(19) United States
(12) Patent Application Publication
(10) Pub. No.: US 2004/0246147 A1
(43) Pub. Date: Dec. 9, 2004

(54) Real time vehicular routing and traffic guidance system

(76) Inventor: J. B. von Grabe, Port Orange, FL (US)

Correspondence Address: NATH & ASSOCIATES, Suite 600, 1030 15th St, NW, Washington, DC, 20005-1509, US

(21) Appl. No.: 09/905,723

(22) Filed: Dec. 8, 2000

(51) Int. Cl. G08G 1/123

(52) U.S. Cl. 340/995.13

(57) ABSTRACT

The invention provides real time information on the flow of vehicles on all roads within territorial boundaries, utilizing GPS enabled cell phones or similar mobile devices as traffic probes. The resulting information is submitted to subscribers, as described infra, and used in multiple applications including, but not limited to, real time vehicle routing; emergency vehicle routing; roadside emergency services requirements indication; traffic management; public agency notification of reduced vehicle flow on roadways; and real time as well as historical flow patterns to agencies responsible for maintaining or designing roads for optimum traffic flow.

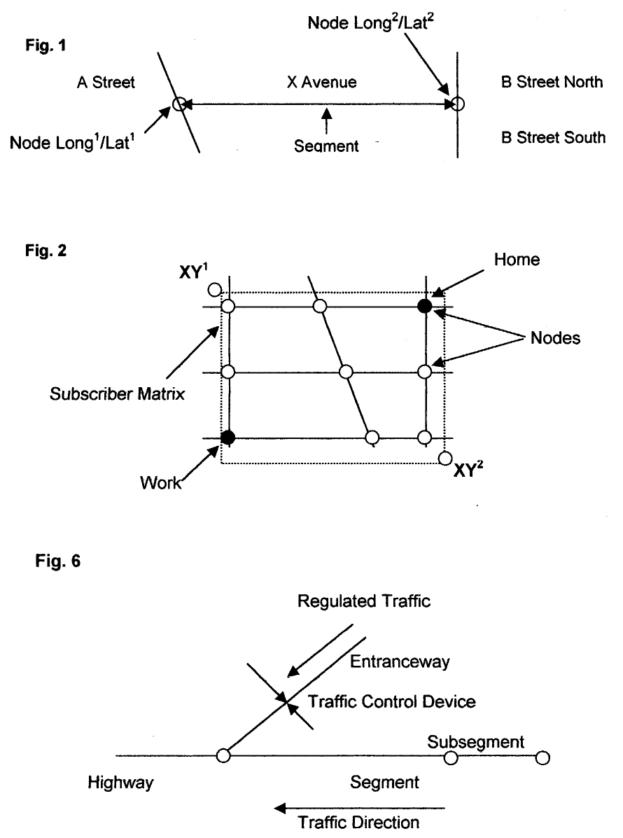

The term ‘subscribers’, as described herein, shall include, but not be restricted to mobile transceiver operators, such as cell phone or GPS enabled display panel users, Internet-enabled computer users, and users of PDAs (personal digital assistance devices), or such other entities as public agencies or the like. The invention describes a system and Method to capture, measure, analyze, and describe a traffic condition in a plurality of predefined grid segments, and supply to a subscriber base multiple levels of services consisting of, among others, alerting subscribers of impending traffic jams, alternatively supplying subscribers via cell phones, vehicle based map display panel, or via the Internet, LANs or WANs, with routing instructions for a subscriber specific route segment (FIG. 1) beginning at node Long¹/Lat¹ and ending at node Long²/Lat² (FIG. 2), or for a set of route segments contained in a subscriber specific, or default stored matrix of routes, beginning at node XY¹/XY¹ and ending at node XY²/XY² (FIG. 2), following a maximum flow algorithm known, for example, as Ford-Fulkerson, Dijkstra, or similar algorithm.

Furthermore, the invention describes a system and method to measure in real time highway traffic in segments, or subsegments, including variable subsegments, ahead of highway entranceways and use the data derived from such measurements to directly control the cycle and length of traffic lights controlling access to the highway (FIG. 6).

### PRIOR ART

U.S. Pat. No. 5,745,865 Traffic control system utilizing cellular telephone system

U.S. Pat. No. 5,465,289 Cellular based traffic sensor system

U.S. Pat. No. 5,402,117 Method of collecting traffic information, and system for performing the method

U.S. Pat. No. 5,182,555 Cell messaging process for an in-vehicle traffic congestion information system

U.S. Pat. No. 5,043,736 Cellular Position Locating System

U.S. Pat. No. 6,150,961 Automated traffic mapping

U.S. Pat. No. 5.933.100 Automobile navigation system with dynamic traffic data

The invention describes a system, incorporating at least one wireless data receiver, capable of receiving from a plurality of participating transmitters, for example GPS enabled cell phones, such data as is required for determining the transmitter identification code, a sign-on code, an optional routing code, describing a selected matrix of preferred and alternative routes (for example home to work), if any, and the location of the transmitter.

The system furthermore incorporates means capable of (1a) either pinging the subscriber's transmitter, as needed to obtain a current location, or (1b) alternatively deriving transmitter specific ID codes, time and location parameters from subscriber specific parameters transmitted periodically in intervals by the participant, for example a cell phone user; (3) comparing said stored parameters with the currently received parameters; and (4) calculating the velocity of a transmitter by comparing previous and current location data, (5) submitting to the subscriber's receiver, PC, PDA, or mapping device, either wireless, by fixed wireless means, or via LAN's, WANs' or Internet, such information as requested or subscribed to, including impeding traffic conditions ahead of the subscribers probable route, and instructions for routing of a subscriber's vehicle through least-impeded segments on a subscriber's selected matrix consisting of at least one route.

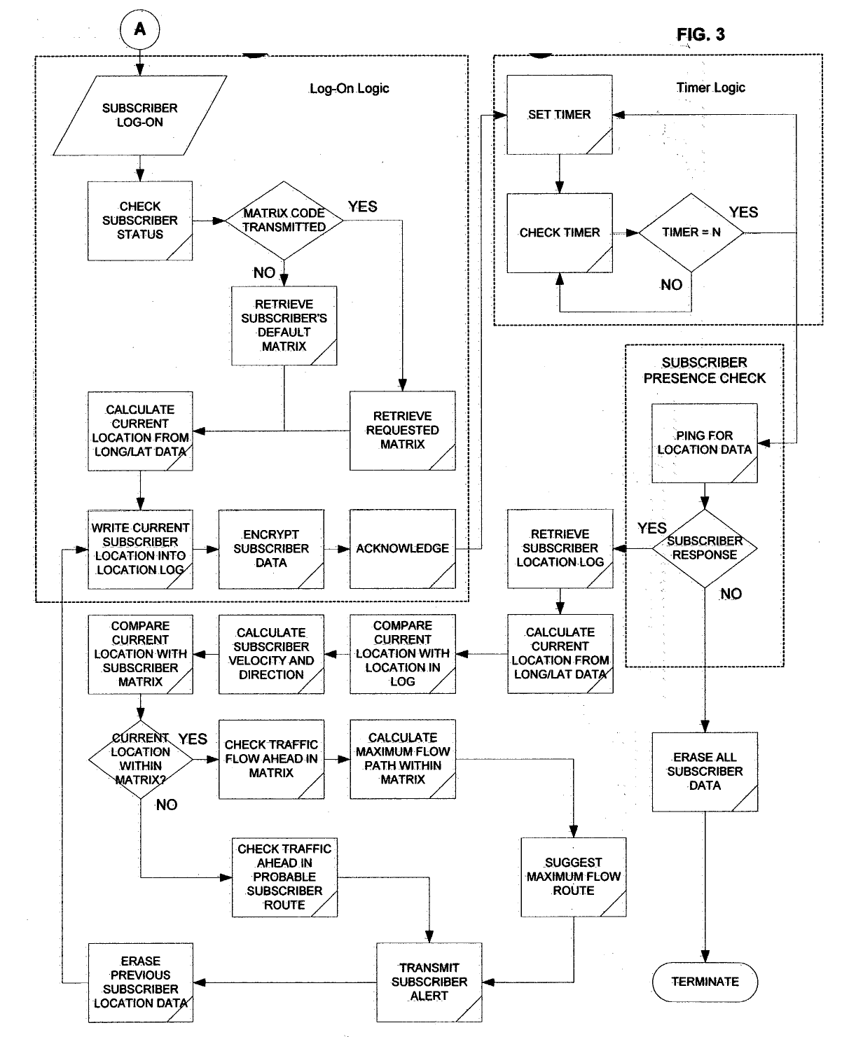

The invention furthermore incorporates such logic as is required to measure, analyze, compare, write into, or retrieve traffic conditions relating to a segment (FIG. 1) contained in a matrix of route segments (FIG. 2) from a record incorporated in a data base, as described as an example in more detail in FIG. 3 Nothing herein shall be construed to exclude variations in the proposed logic.

The said logic is especially capable of capturing location data from a participant, whether a subscriber or not, storing all or part of that data—together with the transmitter identifier in an encrypted form—temporarily in a data base, recapturing the location data with the previously recorded transmitter location in intervals of n seconds, comparing the previous location with the current location and calculating from the analyzed latitude/longitude location information the velocity of the transmitter(s). The said logic is capable of thereafter erasing the previous data and storing instead the current data in the temporary database for further analysis, so that only the latest data is stored.

The logic is specifically capable of probing the location of a plurality of subscribers in the same segment, determining their respective driving direction, average speed, thereby applying principles of fuzzy sets and logic to determine multiple lane speed differences, and calculating the maximum traffic flow for each direction of each segment and optionally each lane within that segment.

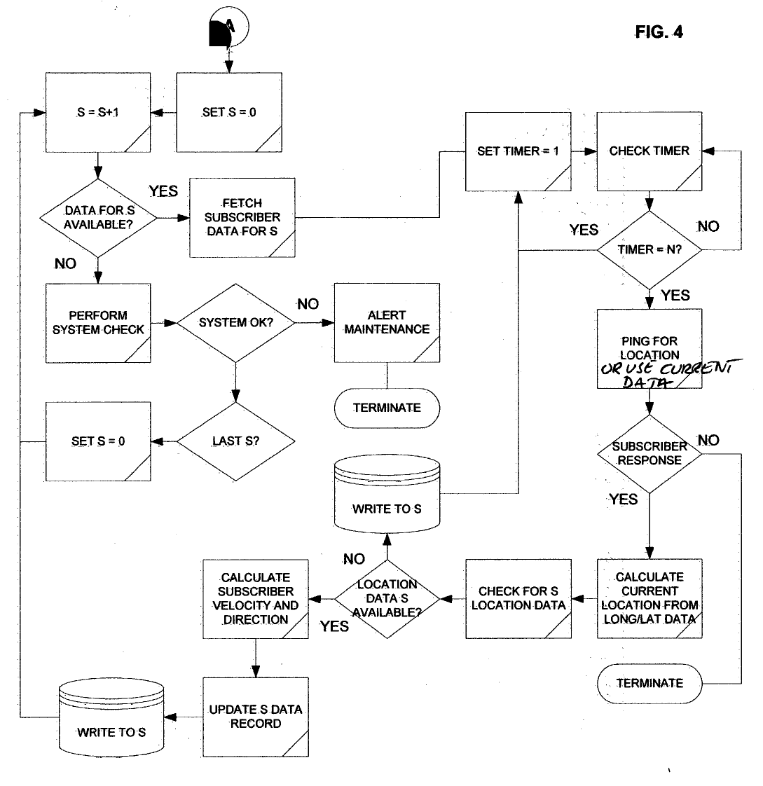

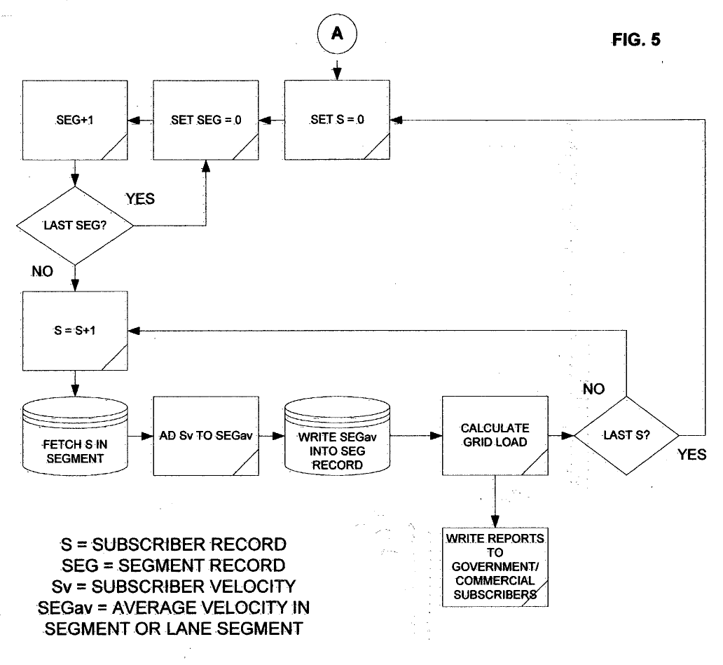

The logic is furthermore capable of thereafter storing that data as n-bit word containing segment identifiers, segment descriptors, max flow values for one direction, max flow values for the opposite direction, average velocity values, lane specific velocity data, and Bezier Curve data for an accurate description of the segment, including its true length. FIGS. 4 and 5 provide a fair description of the process logic for a preferred form of the invention. Nothing herein shall be construed to imply that the examples, given in FIGS. 3 through 6, are exclusive.

The proposed system specifically addresses the issue of privacy by encrypting the subscriber ID, storing the encrypted subscriber ID temporarily in a database accessible to the system only, and erasing any data identifying the subscriber upon completion of a measuring cycle, unless the subscriber opts in by requesting service for which the subscriber ID is required, such as the retrieval of stored matrix data, or real time traffic alerts.

The invention furthermore describes a method to inform a subscriber of traffic conditions on demand by cell phone, or other device, including PDA and computer, whereby flow-impeding traffic conditions ahead of the subscriber's probable route are submitted automatically to the subscriber's cell phone by voice or by cell phone beeper code.

In an alternative expression of the invention, the subscriber can submit a code, for example ‘Star 5’, to access a predefined grid of route segments, stored in the system, to obtain routing instructions for his way to work from home or vice versa, wherein the system calculates maximum flow conditions using, for example, the Ford-Fulkerson, the Dijkstra, or a similar algorithm, and submits to the subscriber the fastest routing alternative within a subscribed or selected matrix (FIG. 2), beginning at XY¹/XY¹ and ending at XY²/XY². The benefits of pre-stored subscriber specified routing grids consists of a significant decrease in computational requirements, compared to a system in which the route beginning at node Long¹/Lat¹ and ending at node Long²/Lat² has to be selected out of the full service area every time a demand for service is submitted.

Furthermore, for the purpose of data mining, the system allows a detailed analysis of at least the average speed encountered per segment and hour, day, month, and year. Such statistical analysis is valuable for public agencies, for example State agencies, which have to plan road construction and maintenance.

Moreover, the system's traffic data collection technology is optionally used to measure traffic conditions, i.e. traffic velocity, traffic density, and lane conditions within a segment or subsegment ahead of a regulated entranceway, as shown in FIG. 6. In conjunction with a traffic control device, located in the entranceway, the proposed method directly influences the frequency and length of the green cycle of said traffic control device, thereby adapting in real time highway access through the entranceway to spontaneous highway traffic fluctuations.

Finally, the proposed system is capable of supplying traffic density data to fixed data receivers, such as modem-connected personal computers and personal digital assistants.

What we claim:

1. System, consisting of
a) at least one wireless data receiver, capable of receiving data from a plurality of mobile transmitters equipped with a Global Positioning System based locator circuitry, where said data shall include at least the transmitter ID code, the sign-on code, the location parameter, and optionally a routing code, and
b) at least one transmitter, capable of transmitting to a subscriber's receiver routing instructions and traffic density data, and
c) computational means, capable of
i) analyzing and temporarily storing said subscriber identification code, location parameters, and optional sign on code,
ii) pinging a subscriber's mobile transmitter in intervals of n seconds to obtain updated location parameters,
iii) extracting from the difference of the original or previous location parameter and the updated location parameter the speed and direction of a subscriber's mobile transmitter,
iv) assigning the directional and velocity data derived from steps ii and iii to a segment characterized by two nodes, i.e. Node Long¹/Lat¹ and Node Long²/Lat²,
v) comparing said directional and velocity data with directional and velocity data of other subscribers in the same segment,
vi) calculating from a multitude of subscriber data, optionally utilizing fuzzy logic algorithms, the average speed within that segment, or in lanes within that segment,
vii) storing the average speed together with directional and optional lane parameters in a segment record for further update and for subscriber routing requests;
viii) looping to ii,
and method for supplying Routing Instructions to Subscribers upon request (opt-in), consisting of
d) analyzing a subscriber requestor's identification code, authorization, location parameters, and optional routing code (for example *5 for work to home routing),
e) associating said routing code to a previously stored subscriber specific matrix of preferred and potential routes (for example work to home related main choice and alternatives), said matrix constraining the number of possible route segments to subscriber selected options within a grid beginning at node XY¹ and ending at node Xy² (FIG. 2),
f) selecting said matrix, consisting of potential routes, associated with the routing code transmitted by the subscriber, from a multitude of stored matrices,
g) analyzing and selecting maximum flow conditions by applying Ford-Fulkerson, Dijkstra or similar algorithms across the matrix,
h) selecting the route meeting the maximum flow condition,
i) and transmitting to a subscriber associated routing instructions as derived from the maximum flow analysis optionally by cell phone, LAN, WAN, or the Internet.

2. System, consisting of
a) at least one wireless data receiver, capable of receiving data from a plurality of mobile transmitters equipped with a Global Positioning System based locator circuitry, where said data shall include at least the transmitter ID code, the sign-on code, the location parameter, and an optional routing code, and
b) at least one transmitter, or other device, capable of transmitting to a subscriber's receiver, or a subscriber's reception device, including a computer or PDA, routing instructions and traffic density data, and
computational means, capable of
i) analyzing and temporarily storing said subscriber identification code, sign on code, and location parameters,
ii) encrypting said identification code,
iii) pinging a subscriber's mobile transmitter in intervals of n seconds to obtain updated location parameters,
iv) retrieving from a data repository previously stored subscriber data,
v) comparing the subscriber position in the previous record with the current subscriber position,
vi) extracting from the difference of the original or previous location parameter, the updated location parameter, and the time elapsed between two measurements the speed and direction of a subscriber's mobile transmitter,
vii) assigning directional, velocity data, derived from steps iii through vi, and optional lane specific information, to a segment in a geographic grid, and storing said segment data in a repository, structured by segments, each segment representing a route segment determined by two longitude/latitude points,
viii) comparing said directional and velocity data with directional and velocity data of other subscribers in the same segment,
ix) calculating from a multitude of subscriber data the average speed for each direction within that segment, or within lanes within that segment,
x) storing the average velocity related to lane or lanes within a segment together with directional parameters in a segment record for further update and for subscriber routing requests,
xi) discarding previous subscriber related data upon completion of the velocity analysis, and storing in encrypted form current subscriber related data until the next computational cycle is executed,
xii) automatically determining and optionally changing the encryption schema in n intervals,
xiii) looping to ii),
and method for supplying Routing Instructions to Subscribers upon request (opt-in), consisting of
j) analyzing a subscriber requestor's identification code, location parameters, and optional routing code (for example *5 for work to home routing), if any,
k) associating said routing code to a previously stored subscriber specific matrix of preferred and potential alternative routes (for example work to home related main choice and alternatives),
l) optionally, where no routing code has been transmitted, selecting a default matrix based upon subscriber's current location and direction,
m) selecting said matrix, consisting of preferred and potential alternative routes, associated with the routing code transmitted by the subscriber,
n) analyzing and selecting maximum flow conditions by applying Ford-Fulkerson, Dijkstra, or similar algorithms across the matrix,
o) selecting the route meeting the maximum flow condition, and
p) transmitting to a subscriber associated routing instructions as derived from the maximum flow analysis.

3. System as set forth in claims 1 or 2 and Method for supplying Routing Instructions to Subscribers upon request (opt-in), said request containing minimum flow condition parameters, consisting of
a) analyzing a subscriber requestor's identification code, location parameters, minimum flow instruction, and current directions,
b) analyzing traffic flow data of segments in the probable route of the subscriber from previously analyzed traffic data,
and submitting traffic alerts to a subscriber if the traffic flow patterns in segments on the probable route of the subscriber indicate that the expected velocity will be below the preselected minimum speed.

4. A system and method for supplying Routing Instructions to Subscribers upon request (opt-in) as set forth in claims 1 through 3, incorporating at least one data repository consisting of structured records, each records representing routing segments, and containing at least
i) the beginning point of said segment expressed as longitude and latitude,
ii) the endpoint of said segment expressed as longitude and latitude,
iii) one data field for the segment direction, for example North, South, East, West,
iv) one data field for the opposite segment direction,
v) one data field for the average velocity measured in one direction of the segment,
vi) optionally one data field each for the average velocity measured in the lane or lanes of the segment in one direction,
vii) one data field for the average velocity measured in the opposite direction of the segment, and
viii) optionally one data field each for the average velocity measured in the lane or lanes of the segment in the opposite direction.

5. A system and method for supplying Routing Instructions to Subscribers upon request (opt-in) as set forth in claims 1 through 4, in which the structure of a record is incorporated in a single n-Bit word containing a composite of at least
i) the beginning point of said segment expressed as longitude and latitude,
ii) the endpoint of said segment expressed as longitude and latitude,
iii) a Bezier descriptor of the segment,
iv) one data field for the geographic direction of the segment, for example NS for North South
v) one data field for the average velocity measured in one direction of the segment,
vi) optionally one data field each for the average velocity measured in the lane or lanes of the segment in one direction,
vii) one data field for the average velocity measured in the opposite direction of the segment, and
viii) optionally one data field each for the average velocity measured in the lane or lanes of the segment in the opposite direction.

6. A system and method for supplying Routing Instructions to Subscribers upon request (opt-in) as set forth in claims 1 through 5, in which the structure of a record is incorporated in a single n-Bit word containing a composite of at least
ix) the beginning point of said segment expressed as longitude and latitude,
x) the endpoint of said segment expressed as longitude and latitude,
xi) a Bezier descriptor of the segment,
xii) one data field for the geographic direction of the segment, for example NS for North South
xiii) one data field for the average velocity measured in one direction of the segment,
xiv) one data field for the average velocity measured in the opposite direction of the segment,
xv) one data field for the average speed of the said segment in one direction during the month
xvi) one data field for the average speed of the said segment in the opposite direction during the month
xvii) one data field for the average speed of the said segment in one direction during the year
xviii) one data field for the average speed of the said segment in the opposite direction during the year

7. A method for supplying Routing Instructions, as set forth in claims 1 through 6, wherein the level of maximum flow is described as one of n levels, whereby O is the level with the least traffic, equivalent to the highest velocity measured, and n is the level with the highest traffic density, equivalent to the lowest measured velocity.

8. A method for supplying Routing Instructions, as set forth in claims 1 through 7, wherein at least one matrix of segments representing preferred routes and its alternatives, selected by a subscriber, is stored in the system's repository and is made available for maximum flow evaluation and subsequent routing instructions by subscriber selection of a code combination.

9. A system and method for supplying Routing Instructions to Subscribers upon request as set forth in claims 1 through 8, wherein routing information is submitted through wireless means to a vehicle onboard Global Positioning System Display capable of displaying routing instructions graphically upon request of the subscriber by changing the color or line thickness of segments displayed on the display console as set forth in their respective flow conditions.

10. A system and method for supplying Routing Instructions to Subscribers upon request as set forth in claims 1 through 9, wherein traffic routing information, supplied to a subscriber, contain the time, or times required to travel the maximum flow route, and the time required to travel alternative routes.

11. A method for supplying Routing Instructions to Subscribers upon request as set forth in claims 1 through 10, wherein the time required for calculating the velocity traveled between two locations is derived by
a) recording the time of the check-in in a subscriber linked record,
b) deducting the time of the previous check-in from the time of the current check-in.

12. A system and method as set forth in claims 1 and 2 wherein traffic density and traffic velocity are being measured within a segment or a subsegment ahead of a highway entranceway, whereby the data derived from such measurement is being used to control the length and frequency of the green cycle of a traffic control device used to allow access to the highway through the entranceway.

13. A system and method as set forth in claims 1 and 2 wherein traffic flow, and traffic velocity are being measured within a segment and a subsegment ahead of a highway entranceway, wherein the subsegment is variable in length, and wherein the length of said subsegment is determined by the general traffic conditions, as the average velocity and density of the traffic within the segment or subsegment.

14. A system and method for supplying Routing and Traffic Control Instructions to Subscribers as set forth in claims 1 through 13, wherein route segments and optionally subsegments are being structured in a data base according to their respective endpoints in Longitude/Latitude format and the shape of the route is described by Bezier curves.

15. A system and method for supplying Routing and Traffic Control Instructions to Subscribers as set forth in claims 1 through 17, wherein traffic conditions within a subscribed matrix or matrices are being transmitted via LANs, WANs, or the Internet to a subscriber's computer.
